(19) United States
(12) Patent Application Publication
(10) Pub. No.: US 2017/0274364 A1
(43) Pub. Date: Sep. 28, 2017

(54) PHOTOCATALYTIC HYDROGEN PRODUCTION FROM WATER OVER CATALYSTS HAVING P-N JUNCTIONS AND PLASMONIC MATERIALS

(71) Applicant: SABIC Global Technologies B.V., Amsterdam (NL)

(72) Inventors: Hicham Idriss, Thuwal (SA); Maher Al-Oufi, Thuwal (SA)

(21) Appl. No.: 15/505,785

(22) PCT Filed: Aug. 21, 2015
(86) PCT No.: PCT/IB2015/001834

§ 371 Date: Feb. 22, 2017

Related U.S. Application Data
(60) Provisional application No. 62/043,859, filed on Aug. 29, 2014.

(51) Int. Cl. B01J 35/00; B01J 23/48; B01J 23/72; C25B 1/04; C01B 13/02; C01B 3/04; C02F 1/32; B01J 21/06; B01J 23/89

(52) U.S. Cl. CPC B01J 35/004; B01J 21/063; B01J 23/48; B01J 23/72; B01J 23/8913; C01B 13/0207; C01B 3/042; C02F 1/32; C25B 1/04

(57) ABSTRACT

A photocatalyst and a method for producing hydrogen and oxygen from water by photocatalytic electrolysis are disclosed. The photocatalyst includes a photoactive material and metal or metal alloy material (15)—e.g. pure particles or alloys of Au, Pd and Ag—capable of having plasmon resonance properties deposited on the surface of the photoactive material. The photoactive material includes a p-n junction (17) formed by contact of a n-type semiconductor material (10), such as mixed phase TiO2 nano particles (anatase to rutile ratio of 1.5 to 1 or greater), and a p-type semiconductor material (16), such as CoO or Cu2O.

### CROSS REFERENCE TO RELATED APPLICATIONS

This application claims benefit to U.S. Provisional Patent Application No. 62/043,859, filed Aug. 29, 2014, titled “PHOTOCATALYTIC HYDROGEN PRODUCTION FROM WATER OVER CATALYSTS HAVING P-N JUNCTIONS AND PLASMONIC MATERIALS”. The entire content of the referenced application is incorporated herein by reference.

### BACKGROUND OF THE INVENTION

A. Field of the Invention

The invention generally concerns photocatalysts that can be used to produce hydrogen from water in photocatalytic reactions. The photocatalysts include photoactive material having a p-n junction and a metal or metal alloy material having surface plasmon resonance properties in response to visible light.

B. Description of Related Art

Hydrogen production from water offers enormous potential benefits for the energy sector, the environment, and the chemical industry (See, for example, Kodama & Gokon, Chem. Rev., 2007, Vol. 107, p. 4048; Connelly & Idriss, Green Chemistry, 2012, Vol. 14, p. 260; Fujishima & Honda, Nature 238:37, 1972; Kudo & Miseki, Chem. Soc. Rev 38:253, 2009; Nadeem, et al., Int. J. Nanotechnology, 2012, Vol. 9, p. 121; Maeda, et al., Nature 2006, Vol. 440, p. 295). While methods currently exist for producing hydrogen from water, many of these methods can be costly, inefficient, or unstable. For instance, photoelectrochemical (PEC) water splitting requires an external bias or voltage and a costly electrode (e.g., Pt-based).

With respect to photocatalytic electrolysis of water from light sources, while many advances have been achieved in this area, most materials are either unstable under realistic water splitting conditions or require considerable amounts of other components (e.g., large amounts of sacrificial hole or electron scavengers) to work, thereby offsetting any gained benefits. By way of example, a semiconductor photocatalyst is a material that can be excited upon receiving energy equal to or higher than its electronic band gap. Upon photo-excitation, electrons are transferred from the valence band (VB) to the conduction band (CB), resulting in the formation of an excited electron (in the CB) and a hole (in the VB). In the case of water splitting, electrons in the CB reduce hydrogen ions to H₂ and holes in the VB oxidize oxygen ions to O₂. One of the main limitations of most photocatalysts is the fast electron-hole recombination, a process that occurs at the nanosecond scale, while the oxidation-reduction reactions are much slower (microsecond time scale). Many approaches have been conducted in order to design a photocatalyst that can work under direct sun light in stable conditions. Problems associated with these types of systems include light absorption efficiency, charge carrier life time, and materials stability. In order to enhance light absorption a large number of photocatalysts were designed based on visible light range band gap either by solid solutions, hybrid materials, or doping of wide band gap semiconductors. In order to decrease the charge carrier's life time hydride semiconductors, addition of metal nanoparticles, and the use of sacrificial agents are currently used (See, for example, Connelly et al, Green Chemistry, 2012, Vol. 14, pp. 260-280; Nadeem et al., Int. J. Nanotechnology, Special edition on Nanotechnology in Scotland, 2012, Vol. 9, pp. 121-162; Connelly et al., Materials for Renewable and Sustainable Energy, 2012, Vol. 1, pp. 1-12; Walter et al, Chem. Rev., 2010, Vol. 110, pp. 6446-6473; and Yang et al., Appl. Catal. B: Environmental, 2006, Vol. 67, pp. 217-222). Ultimately, however, over 90% of photo-excited electron-hole pairs disappear/recombine prior to performing the desired water splitting reaction, thereby making the currently available photocatalysts inefficient (See, for example, Yamada, et al., Appl Phys Lett., 2009, Vol. 95, pp. 121112-121112-3).

International Patent Application No. WO 2012/052624 attempts to solve the above described problems by use of nitrogen as a doping agent on titanium oxide nano fibers. The nitrogen doped titanium nano fibers include high work function material or p-type semiconductors that make p-n junctions with n-doped titanium dioxide. These types of photocatalysts are expensive to manufacture and suffer from non-uniform phase structures. Doping of TiO₂ and other n-type semiconductors with anions (such as N, C, and S anions) has been pursued for a while but has not achieved the desired results. While it expands the absorption to the visible range, the activity of the doped semiconductor is less than that of the un-doped semiconductor when excited with full solar spectrum (including UV light irradiation). This is largely due to the uncontrolled defects introduced upon doping with these anions (See, for example, Luoa et al., Int. J. Hydrogen Energy, 2009, Vol 34, pp. 125-129; Kudo et al., Chem. Soc. Rev 2009, Vol. 38, p. 253; and Jesus et al., J. Am. Chem. Soc. 2008, Vol. 130, pp. 12056-12063.)

International Patent Application Publication No. 2014/046305 attempts to solve the problems above described problems by immobilizing two different types of particles on a substrate. One type of particle includes hydrogen generating photocatalyst particles and a second type of particle includes oxygen generating photocatalyst particles. While the particles are in contact with one another, charge carrier diffusion is limited by the bulk and surface structure of the individual particles.

### SUMMARY OF THE INVENTION

A solution to the aforementioned inefficiencies surrounding current water-splitting photocatalysts has been discovered. In particular, the solution resides in a photoactive material that provides more efficient production of hydrogen and oxygen from water-splitting reactions as compared to current photocatalysts. The enhancement is due to the combination of a plasmon resonance material and a p-n junction in a photoactive material, which increase the charge carrier lifetime of the photoactive material. The p-n junction is formed by contact of an n-type semiconductor material with a p-type semiconductor material in the photoactive material. The p-n junction interacts with the plasmon resonance material in response to visible light and/or infrared light, and produces hydrogen more efficiently than photocatalysts without these features. Without wishing to be bound by theory, it is believed that a depletion region is formed proximate the p-n junction, and that the width of the depletion region can assist in slowing or inhibiting the occurrence of electron-hole recombination. By placing metal nanoparticles at the interface of the p-n junction of the photoactive material, the metal nanoparticles in response to visible light can generate an external electric field at the p-n junction. The external electric field causes an increase in the width of the depletion region, which assists in the promotion of excited electrons and holes to the surface of the photoactive material so that they can participate in the oxidation/reduction reaction of water instead of recombining. The discovery also lies in the selection of the p-type semiconductor nanoparticles and the n-type semiconductor materials. The n-type semiconductor materials of the present invention can be a metal oxide (for example, TiO₂ or ZnO) having a large band gap (for example >3.0 eV). The p-type semiconductor of the present invention can be a metal oxide (for example, Cu₂O, PbO, or CoO) that has a narrow band gap (for example 2.1-2.6 electron volts (eV)) which allows for better utilization of the solar system wavelengths, and/or a conduction band of up to 0.5 eV more negative than the hydrogen reduction potential. It is believed that the combination of the materials of the present invention slows the electron-hole recombination process.

Without wishing to be bound by theory, it is also believed that by placing both the nanoparticle p-type semiconductor material and plasmon resonance material on the surface of the n-type semiconductor the efficiency of hydrogen and oxygen production is enhanced because (1) a p-n junction is formed, which assists in promoting the charge carriers (electrons and holes) to the surface of the photoactive material, (2) the width of the depletion region at the p-n junction is increased through an applied external electrical field at the p-n junction, which also assists in promoting charge carriers (electrons and holes) to the surface of the photoactive material, and (3) the promoted electrons are trapped at the surface of the photoactive material by metal or metal alloy materials that have plasmon resonance properties in response to visible light. Without wishing to be bound by theory, it is believed that these properties increase the charge carrier lifetime. Therefore, more holes and electrons participate in the water-splitting reaction rather than recombining. Furthermore, when the metal or metal alloy material is a noble metal or noble metal alloy, the proximity of the nanoparticle p-type semiconductor material to the noble metal material helps prevent oxidation of the p-n junction material due to the reducible nature of the noble metal material. In sum, the photocatalyst of the present invention has a combination of the following properties (1) surface plasmons (Au, Ag, AuAg, or Ag—Pd), (2) metal-semiconductor interface properties (Au/n-type semiconductor material and Pd/n-type semiconductor material), and (3) a semi-conductor to semi-conductor interface making a p-n junction. Such photocatalysts are capable of efficiently producing hydrogen and oxygen from water.

Hydrogen and oxygen production in water-splitting reactions can be further enhanced by using titanium dioxide particles having rutile and anatase phases as the n-type semiconductor material. The titanium dioxide particle can be a mixture of rutile and anatase titanium particles or a mixed phase titanium particle having anatase and rutile phases. Without wishing to be bound by theory, it is believed that when rutile nanoparticles are formed on the surface of the single phase anatase nanoparticles, the electron-hole recombination rate is retarded due to electron transfer from the rutile to the anatase phase. In other words, because the electron-hole recombination rate is fast in rutile and slow in anatase (See, for example, Xu, et al. in Topological Features of Electronic Band Structure and Photochemistry: New Insights from Spectroscopic Studies on Single Crystal Titania Substrates. Physics Review Letters 2011, Vol. 106, pp. 138302-1 to 138302-4) and because the number of electron and holes is higher in rutile than in anatase at a given wavelength capable of exciting both materials, the mixture performs better in photocatalytic water-splitting reactions. The materials benefit from a large number of carriers (in rutile) and a slow rate of recombination (in anatase) giving them more time to make the reduction of hydrogen ions to hydrogen molecules and the oxidation of oxygen ions to oxygen molecules. Thus, a titanium dioxide photocatalyst of the present invention combines surface plasmon, metal-semiconductor interface, p-n junction, with the synergistic effect of anatase and rutile phases in the titanium dioxide.

The above properties result in more efficient production of hydrogen and oxygen production from water as compared to a photocatalyst prepared without photoactive material having a p-n junction interface or a photocatalyst prepared with a photoactive material having a plasmon resonance material deposited on its surface. The improved efficiency of the photocatalyst of the present invention allows for a reduced reliance on additional materials such as the use of nitrogen or sulfur doped materials or the use of sacrificial agents, thereby decreasing the complexity and costs associated with using the photocatalysts in water-splitting applications and systems.

In one particular aspect of the invention, a photocatalyst includes (a) a photoactive material that includes a p-n junction material present at an interface of a p-type semiconductor and a n-type semiconductor material, and (b) a metal or metal alloy material deposited on the surface of the photoactive material and have surface plasmon resonance properties in response to visible light and/or infrared light. The n-type semiconductor material can include titanium dioxide or zinc oxide. The titanium dioxide can have a ratio of anatase to rutile of greater than or equal to 20:10 to 80:20. Without wishing to be bound by theory, it is believed that using a mixture of anatase and rutile phase photoactive TiO₂ particles at a ratio of at least 1.5:1 of anatase to rutile, coupled with the use of the plasmon resonance material and a p-n junction, reduces the likelihood that an excited electron will spontaneously revert back to its non-excited state (i.e., the electron-hole recombination rate can be reduced or delayed for a sufficient period of time). In particular, it is believed that this ratio allows for the efficient transfer of charge carriers (electrons) from the rutile phase to the anatase phase, where said charge carries in the anatase phase have an increased chance of being transferred to the metal conducting materials rather than undergoing an electron-hole recombination event. The p-type semiconductor material can preferably include cobalt (II) oxide or copper (I) oxide, lead oxide, or more preferable cobalt (II) oxide. A ratio of the n-type semiconductor material to the p-type semiconductor material can be 75:25, preferably 80:20, or more preferably 95:5. In a preferred aspect of the invention, the n-type semiconductor includes titanium dioxide having a ratio of anatase to rutile of greater than or equal to 1.5:1 or 2:1, and the p-type semiconductor material includes cobalt (II) oxide. The metal or metal alloy material can be gold, silver-palladium alloy, gold-palladium alloy, gold-silver, or any combination thereof. The photoactive material can include less than 5, 4, 3, 2, 1, 0.5 or 0.1 wt. % of the metal or metal alloy material. In certain instances, the metal or metal alloy material does not cover more than 30, 20, 10, 5, 2, or 1% of the surface area of the photoactive material and still efficiently produce hydrogen from water. The combination of Au, Pd, and Ag particles has been found to be particularly advantageous, as Pd and Au can conduct excited electrons away from their corresponding holes in the photoactive material and “trap” them at the photocatalyst surface. These metals can also catalyze hydrogen-hydrogen recombination to hydrogen molecules. Au and Ag can enhance performance via resonance plasmonic excitation from visible light, thus allowing the photocatalyst to capture a broader range of light energy. In embodiments when Au is used, the gold can act as a sink for transferred electrons from the conduction band and it contributes by its plasmon response in response to visible light in the electron transfer reaction. In particular embodiments, the n-type semiconductor material, the p-type semiconductor material, and the metal or the metal alloy materials are each in the form of nanostructures. The nanostructures can be nanowires, nanoparticles, nanoclusters, or nanocrystals, or combinations thereof. The photocatalyst can be self-supported (i.e., it is not supported by a substrate) or it can be deposited onto a substrate. Non-limiting examples of substrates include indium tin oxide substrate, a stainless steel substrate, silicon oxide, aluminum oxide, zirconium oxide, or magnesium oxide. The photocatalysts of the present invention are capable of splitting water in combination with a light source. No external bias or voltage is needed to efficiently split water. The hydrogen production rate from water can be modified as desired by increasing or decreasing the amount of light or light flux that the system is subjected to. In particular aspects, the photocatalysts of the present invention can be used in water splitting systems to provide a hydrogen production rate from water between 5×10⁻⁵ and 5×10⁻⁴ mol/g_{Catal} min with a light source having a ultraviolet flux from about 0.3 to 5 mW/cm². In some aspects of the present invention, the ratio of H₂ to CO₂ produced is from 8 to 50. In addition to being capable of catalyzing water splitting without an external bias or voltage, the photocatalysts of the present invention can be included in an anode of an electrochemical cell capable of forming oxygen and hydrogen by electrolysis of water. In some instances, the photocatalysts of the present invention are capable of catalyzing the photocatalytic oxidation of an organic compound.

Also disclosed is a composition containing a photocatalyst of the invention, water, and a sacrificial agent that can be used for water splitting. With a light source, the water can be split and hydrogen and oxygen gas formation can occur. In particular instances, the sacrificial agent may further prevent electron/hole recombination. In some instances, the composition contains 0.1 to 2 g/L of the photocatalyst. Notably, the efficiency of the photocatalysts of the present invention allows for one to use substantially low amounts (or none at all) of sacrificial agent when compared to known systems. In particular instances, 0.1 to 10 w/v %, or preferably 2 to 7 w/v %, of the sacrificial agent can be included in the composition. Non-limiting examples of sacrificial agents that can be used include methanol, ethanol, propanol, butanol, iso-butanol, methyl tert-butyl ether, ethylene glycol, propylene glycol, glycerol, oxalic acid, or any combination thereof. In particular aspects, ethylene glycol, glycerol, or a combination thereof is used.

In another aspect of the present invention there is disclosed a system for producing hydrogen gas and/or oxygen gas from water. The system can comprise a container and a composition that includes a photocatalyst of the present invention, water, and optionally a sacrificial agent. The container in particular embodiments is transparent or translucent. Containers can also include opaque containers such as those that can magnify light (e.g., opaque container having a pinhole(s)). The system can also include a light source for irradiating the composition. The light source can be natural sunlight or can be from a non-natural or artificial source such as a UV lamp. While the system can use an external bias or voltage, such an external bias or voltage is not needed due to the efficiency of the photocatalysts of the present invention.

In another embodiment, there is disclosed a method for producing hydrogen gas by photocatalytic electrolysis, the method comprising irradiating an aqueous electrolyte solution comprising any of the compositions described above with light in an electrolytic cell having an anode and a cathode, the anode comprising any of the photocatalysts described above, whereby a voltage between the anode and the cathode is produced and water molecules are split to form hydrogen and oxygen. The method can be practiced such that the hydrogen production rate from water can be modified as desired by increasing or decreasing the amount of light or light flux that the system is subjected to. In particular aspects, the method can be practiced such that the hydrogen production rate from water is between 5×10⁻⁵ and 5×10⁻⁴ mol/g_{Catal} min with a light source having a flux from about 0.3 to 5 mW/cm². In some aspects, the ratio of H₂ to CO₂ produced is from 8 to 50. In particular embodiments, the light source can be natural sunlight. However, non-natural or artificial light sources (e.g., ultraviolet lamp, infrared lamp, etc.) can also be used alone or in combination with said sunlight.

In the context of the present invention, thirty-three (33) embodiments are described. Embodiment 1 is a photocatalyst that includes a photoactive material that includes a n-type semiconductor material and a p-type semiconductor material, wherein a p-n junction is present at an interface of the p-type and n-type materials; and a metal or metal alloy material having surface plasmon resonance properties in response to visible light and/or infrared light, wherein the metal or metal alloy material is deposited on the surface of the photoactive material. Embodiment 2 is the photocatalyst of embodiment 1, wherein the n-type semiconductor material comprises titanium dioxide or zinc oxide. Embodiment 3 is the photocatalyst of embodiment 2, wherein the n-type semiconductor material comprises titanium dioxide that has an anatase to rutile ratio of greater than or equal to 1.5:1. Embodiment 4 is the photocatalyst of embodiment 4, wherein the anatase to rutile ratio is about 80:20. Embodiment 5 is the photocatalyst of any one of embodiments 1 to 4, wherein the p-type semiconductor material comprises cobalt (II) oxide or copper (I) oxide. Embodiment 6 is the photocatalyst of embodiment 5, wherein the p-type semiconductor material comprises cobalt (II) oxide. Embodiment 7 is the photocatalyst of embodiment 1, wherein the n-type semiconductor material comprises titanium dioxide having an anatase to rutile ratio of greater than or equal to 2:1 and the p-type semiconductor material comprises cobalt (II) oxide. Embodiment 8 is the photocatalyst of any one of embodiments 1 to 7, wherein the metal or metal alloy material is gold, silver-gold-palladium alloy, or silver-palladium alloy, respectively, or a mixture thereof. Embodiment 9 is the photocatalyst of any one of embodiments 1 to 8, wherein the n-type material, the p-type material, and the metal or metal alloy material are each in particulate form. Embodiment 10 is the photocatalyst of embodiment 9, wherein the n-type material, the p-type material, and the metal or metal alloy material are each nanostructures. Embodiment 11 is the photocatalyst of embodiment 10, wherein the nanostructures are nanowires, nanoparticles, nanoclusters, or nanocrystals, or combinations thereof. Embodiment 12 is the photocatalyst of any one of embodiments 1 to 11, comprising less than 5, 4, 3, 2, 1, 0.5 or 0.1 wt. % of the metal or metal alloy material. Embodiment 13 is the photocatalyst of any one of embodiments 1 to 12, wherein the metal or metal alloy material does not cover more than 30, 20, 10, 5, 2, or 1% of the surface area of the photoactive material. Embodiment 14 is the photocatalyst of any one of embodiments 1 to 13, wherein the ratio of the n-type semiconductor material to the p-type semiconductor material is 75 to 25, or 80 to 20, or 95 to 5. Embodiment 15 is the photocatalyst of any one of embodiments 1 to 14, wherein the photocatalyst is deposited onto a substrate such as an indium tin oxide substrate, a stainless steel substrate, silicon oxide, aluminum oxide, zirconium oxide, or magnesium oxide. Embodiment 16 is the photocatalyst of any one of embodiments 1 to 15, wherein the photocatalyst is capable of catalyzing the photocatalytic electrolysis of water. Embodiment 17 is the photocatalyst of embodiment 16, wherein the photocatalyst is comprised in an anode of an electrochemical cell capable of forming oxygen and hydrogen by electrolysis of water. Embodiment 18 is the photocatalyst of any one of embodiments 1 to 17, wherein the photocatalyst is capable of catalyzing the photocatalytic oxidation of an organic compound.

Embodiment 19 is a composition that includes the photocatalyst of any one of embodiments 1 to 18. Embodiment 20 is the composition of embodiment 19 that includes 0.1 to 2 g/L of the photocatalyst. Embodiment 21 is the composition of any one of embodiments 19 to 20, further including water. Embodiment 22 is the composition of embodiment 21, further including a sacrificial agent. Embodiment 23 is the composition of embodiment 22, wherein the sacrificial agent is methanol, ethanol, propanol, butanol, iso-butanol, methyl tert-butyl ether, ethylene glycol, propylene glycol, glycerol, or oxalic acid, or any combination thereof. Embodiment 24 is the composition of embodiment 23, wherein the sacrificial agent is ethylene glycol or glycerol or a combination thereof. Embodiment 25 is the composition of any one of embodiments 22 to 24 that includes 1 to 10 w/v % or 2 to 7 w/v % of the sacrificial agent.

Embodiment 26 is a water splitting system that includes a transparent container comprising the composition of any one of embodiments 19 to 25, and a light source for irradiating the aqueous solution.

Embodiment 27 is a method of producing hydrogen gas by photocatalytic electrolysis. The method includes irradiating an aqueous electrolyte solution comprising the composition of any one of embodiments 21 to 25 with light in an electrolytic cell having an anode and a cathode, the anode comprising the photocatalyst of any one of embodiments 1 to 18, whereby a voltage between the anode and the cathode is produced and water molecules are split to form hydrogen and oxygen. Embodiment 28 is the method of embodiment 27, wherein the hydrogen production rate is from 5×10⁻⁵ to 5×10⁻⁴ mol/g_{Catal} min. Embodiment 29 is the method of any one of embodiments 27 to 28, wherein the ratio of H₂ to CO₂ produced is from 8 to 50. Embodiment 30 is the method of any one of embodiments 27 to 30, wherein the light comprises ultraviolet light. Embodiment 31 is the method of embodiment 30, wherein the ultraviolet light luminous flux is from 0.3 to 5 mW/cm². Embodiment 32 is the method of embodiment 31, wherein the light is from sunlight. Embodiment 33 is the method of embodiment 31, wherein the light is from an artificial source such as from an ultraviolet lamp.

The following includes definitions of various terms and phrases used throughout this specification.

“Water splitting” or any variation of this phrase describes the chemical reaction in which water is separated into oxygen and hydrogen.

“Inhibiting,” “preventing,” or “reducing” or any variation of these terms, when used in the claims or the specification includes any measurable decrease or complete inhibition to achieve a desired result. By way of example, reducing the likelihood for an excited electron in the conductive band to recombine with a hole in the valence band encompasses situations where a decrease in the number of electron/hole recombination events occurs or an increase in the time it takes for an electron/hole recombination event to occur such that the increase in time allows for the electron to reduce hydrogen ions rather than to recombine with its corresponding hole. In either instance, the photocatalysts of the present invention can be compared with photocatalysts that do not have a p-n junction interface.

“Depletion region” is when the p-n junction is in a steady state. The region has charged ions adjacent to the interface in the region with no mobile carriers. The uncompensated ions are positive on the n-side and negative on the p-side.

“Effective” or any variation of this term, when used in the claims or specification, means adequate to accomplish a desired, expected, or intended result.

“Nanostructure” refers to an object or material in which at least one dimension of the object or material is equal to or less than 100 nm (e.g., one dimension is 1 to 100 nm in size). In a particular aspect, the nanostructure includes at least two dimensions that are equal to or less than 100 nm (e.g., a first dimension is 1 to 100 nm in size and a second dimension is 1 to 100 nm in size). In another aspect, the nanostructure includes three dimensions that are equal to or less than 100 nm (e.g., a first dimension is 1 to 100 nm in size, a second dimension is 1 to 100 nm in size, and a third dimension is 1 to 100 nm in size). The shape of the nanostructure can be of a wire, a particle, a sphere, a rod, a tetrapod, a hyper-branched structure, or mixtures thereof.

The terms “about” or “approximately” are defined as being close to as understood by one of ordinary skill in the art, and in one non-limiting embodiment the terms are defined to be within 10%, preferably within 5%, more preferably within 1%, and most preferably within 0.5%.

The use of the word “a” or “an” when used in conjunction with the term “comprising” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The photocatalysts and photoactive materials of the present invention can “comprise,” “consist essentially of,” or “consist of” particular components, compositions, ingredients, etc. disclosed throughout the specification. With respect to the transitional phase “consisting essentially of,” in one non-limiting aspect, a basic and novel characteristic of the photoactive catalysts and materials of the present invention are their ability to efficiently use excited electrons in water-splitting applications to produce hydrogen.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description.

### BRIEF DESCRIPTION OF THE DRAWINGS

FIGS. 1A-D are a schematic of photoactive material comprising anatase and rutile phase particles in which the particles are in contact with one another: (A) larger anatase particles; (B) larger rutile phase particles; (C) similar sized particles; (D) films of anatase and rutile.

FIGS. 2A-C are Transmission Electron Microscopy (TEM) images of different titanium dioxide based catalyst with anatase, brookite and rutile phases, respectively.

FIG. 3 is a schematic of a photoactive catalyst of the present invention.

FIG. 4 is a schematic of a water splitting system of the present invention.

FIG. 5 is a ultra violet/visible absorption spectrum of CoO—TiO₂ semiconductor material with 2 wt. % cobalt oxide and 0.5 wt. % cobalt oxide, respectively.

FIG. 6 is a ultra violet/visible absorption spectrum of Ag—Pd/CoO—TiO₂ semiconductor photocatalyst of the present invention with 0.1 wt. % silver, 0.4 wt. % palladium, 2 wt. % cobalt oxide on TiO₂ and TiO₂.

FIG. 7 is a graph of hydrogen production versus time for a Ag—Pd/CoO/TiO₂ semiconductor photocatalyst of the present invention with 0.1 wt. % silver, 0.4 wt. % palladium, 2 wt. % cobalt oxide on TiO₂ and the TiO₂.

FIG. 8 is a graph of hydrogen production versus time for a comparative CoO/TiO₂ photocatalyst with 2 wt. % of cobalt oxide

FIG. 9 is a graph of hydrogen production versus time for the comparative Ag—Pd/TiO₂ photocatalyst having 0.1 wt. % silver and 0.4 wt. % palladium.

### DETAILED DESCRIPTION OF THE INVENTION

While hydrogen-based energy from water has been proposed by many as a solution to the current problems associated with carbon-based energy (e.g., limited amounts and fossil fuel emissions), the currently available technologies are expensive, inefficient, and/or unstable. The present application provides a solution to these issues. The solution is predicated on the use of photocatalysts that employ a p-type semiconductor material, a n-type semiconductor, wherein a p-n junction is formed between the p-type and n-type materials, and a metal or a metal alloy that have surface plasmon resonance properties in response to visible light. This combination results in efficient production of hydrogen and oxygen by reducing electron/hole recombination events and increasing water splitting reactions. Further, the increased water-splitting efficiency of the photocatalysts of the present invention allows a reduction in or avoidance of other costly materials such as sacrificial agents that are used in water splitting reactions.

These and other non-limiting aspects of the present invention are discussed in further detail in the following sections.

### A. Photoactive Catalysts

The photoactive material includes any n-type semiconductor material able to be excited by light in a range from 360-600 nanometers. In a preferred embodiment, the photoactive material is titanium dioxide or zinc oxide. Titanium dioxide can be in the form of three phases, the anatase phase, the rutile phase, and the brookite phase. Anatase and rutile phases have a tetragonal crystal system, whereas the brookite phase has an orthorhombic crystal system. While anatase and rutile both have a tetragonal crystal system consisting of TiO₆ octahedra, their phases differ in that anatase octahedras are arranged such that four edges of the octahedras are shared, while in rutile, two edges of the octahedras are shared. These different crystal structures resulting in different density of states may account for the different efficiencies observed for transfer of charge carriers (electrons) in the rutile and anatase phases and the different physical properties of the catalyst. For example, anatase is more efficient than rutile in the charge transfer, but is not as durable as rutile. Each of the different phases can be purchased from various manufactures and supplies (e.g., Titanium (IV) oxide anatase Nano powder and Titanium (IV) oxide rutile Nano powder in a variety of sizes and shapes can be obtained from Sigma-Aldrich® Co. LLC (St. Louis, Mo., USA) and from Alfa Aesar GmbH & Co KG, A Johnson Matthey Company (Germany)); all phases of titanium dioxide from L.E.B. Enterprises, Inc. (Hollywood, Fla. USA)). They can also be synthesized using known sol-gel methods (See, for example, Chen et al., Chem. Rev. 2010 Vol. 110, pp. 6503-6570, the contents of which are incorporated herein by reference).

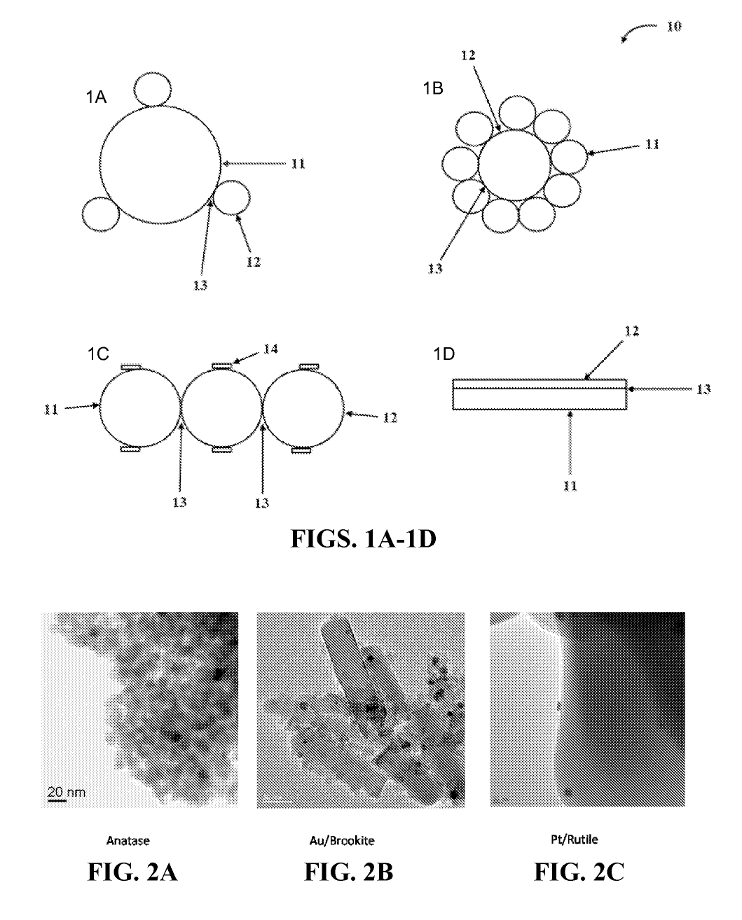

Referring to FIG. 1, n-type semiconductor material 10 of the present invention can take a variety of different forms. By way of example only, anatase particles 11 can be larger than rutile phase particles 12 (FIG. 1A). Alternatively, rutile particles 12 can be larger than anatase particles 11 (FIG. 1B). Still further, anatase 11 and rutile 12 particles can be substantially the same size (FIG. 1C). Brookite particles 14 can also be included in the n-type semiconductor material 10 (FIG. 1C). While the particles in FIG. 1 are illustrated as spheres, other shapes such as rod-shaped and irregularly shaped particles are contemplated. In other instances, the anatase 11 and rutile 12 phases can be formed into sheets or films (FIG. 1D). FIGS. 2A-2C depict TEM of titanium dioxide catalysts. FIG. 2A is a TEM of titanium dioxide anatase particles. The titanium dioxide anatase particles are about 15 nm in size. FIG. 2B is a TEM of titanium dioxide brookite particles with gold particles deposited on the top. FIG. 2C is a TEM of titanium dioxide rutile particles (grey area) with platinum (dark spots) deposited on the surface.

In one aspect of the invention, mixed phase titanium dioxide anatase and rutile may be the transformation product obtained from heat-treating single phase titanium dioxide anatase at selected temperatures. Heat-treating the single phase titanium dioxide anatase nanoparticle produces small particles of rutile on top of anatase particles, thus maximizing the interface between both phases and at the same time allowing for a large number of adsorbates (water and ethanol) to be in contact with both phases, due to the initial small particle size. Single phase TiO₂ anatase nanoparticles that are transformed into mixed phase TiO₂ nanoparticles have a surface area of about 45 to 80 m²/g, or 50 m²/g to 70 m²/g, or preferably about 50 m²/g. The particle size of these single phase TiO₂ anatase nanoparticles is less than 95 nanometers, less than 50 nm, less than 20, or preferably between 10 and 25 nm. Heat treating conditions can be varied based on the TiO₂ anatase particle size and/or method of heating (See, for example, Hanaor et al. in Review of the anatase to rutile phase transformation, J. Material Science, 2011, Vol. 46, pp. 855-874), and are sufficient to transform single phase titanium dioxide to mixed phase titanium dioxide anatase and rutile. Other methods of making mixed phase titanium dioxide materials include flame pyrolysis of TiCl₄, solvothermal/hydrothermal methods, chemical vapor deposition, and physical vapor deposition methods. A non-limiting example of transforming nanoparticles of TiO₂ anatase nanoparticles to mixed phase TiO₂ anatase and rutile nanoparticles includes heating single phase TiO₂ anatase nanoparticles isochronally at a temperature of 700-800° C. for about 1 hour to transform the nanoparticles of TiO₂ anatase phase to nanoparticles of mixed phase TiO₂ anatase phase and rutile phase. In a preferred embodiment, titanium dioxide anatase is heated to a temperature of 780° C. to obtain mixed phase titanium dioxide containing about 37% rutile. Without wishing to be bound by theory, it is believed that this ratio and the particle structure may allow for the efficient transfer of charge carriers (electrons) from the rutile phase to the anatase phase, where said charge carries in the anatase phase have an increased chance of being transferred to the metal conducting materials rather than undergoing an electron-hole recombination event. The percentage of anatase to rutile in the titanium dioxide polymorph can be determined using powder X-ray diffraction (XRD) techniques. For example, a Philips X'pert-MPD X-ray powder diffractometer may be used to analyze powder samples of titanium dioxide polymorphs. Using the areas of these peaks the amounts of rutile phase in the titanium dioxide polymorph can be determined using the following equation:

$$\% rutile = \frac{1}{( \frac{A}{R} \times 0.884 ) + 1} \times 100 \qquad ( 1 )$$

where A is the area of anatase peak (such as that of the (101) plane); R is the area of rutile peak (such as that of the (101) plane); as determined by XRD; and 0.884 is a scattering coefficient.

Notably, it was discovered that when a ratio of anatase to rutile of 1.5:1 or greater is used, the photocatalytic activity of the n-type semiconductor material (10) can be substantially increased. The mixed phase TiO₂ nanoparticles of the present invention can have a ratio of anatase and rutile phase ranges from 1.5:1 to 10:1, from 6:1 to 5:1, from 5:1 to 4:1, or from 2:1. As explained above, it is believed that this ratio allows for the efficient transfer of charge carriers (electrons) from the rutile phase to the anatase phase, where said charge carries in the anatase phase have an increased chance of being transferred to the metal conducting materials rather than undergoing an electron-hole recombination event.

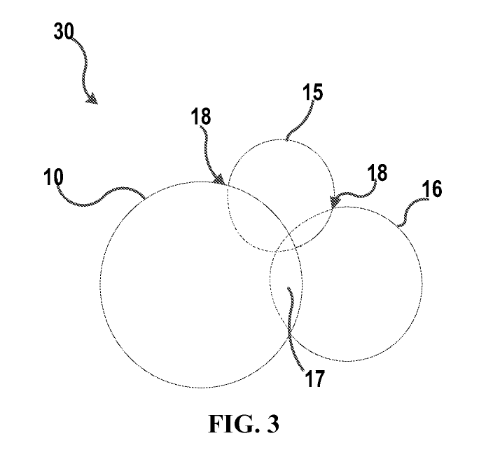

The plasmon resonance material can be metal or metal alloys. The metal or metal alloys can be obtained from a variety of commercial sources in a variety of forms (e.g., particles, rods, films, etc.) and sizes (e.g., Nano scale or Micro scale). By way of example, each of Sigma-Aldrich® Co. LLC and Alfa Aesar GmbH & Co KG offer such products. Alternatively, they can be made by any process known by those of ordinary skill in the art. In a non-limiting aspect, the metal particles (element 15 in FIG. 3) can be prepared using co-precipitation or deposition-precipitation methods (Yazid et al.). The metal particles 15 can be used as conductive material for the excited electrons to ultimately reduce hydrogen ions to produce hydrogen gas. The metal particles 15 can be substantially pure particles 15 of Au, Pd, and Ag. The metal particles 15 can also be binary or tertiary alloys of Au, Pd, and/or Ag. The metal particles 15 are highly conductive materials, making them well suited to act in combination with the photoactive material 10 to facilitate transfer of excited electrons to hydrogen before an electron-hole recombination event occurs or by increasing the time that such an event occurs. The metal particles 15 can also enhance efficiency via resonance plasmonic excitation from visible light, enabling capture of a broader range of light energy. The metal particles 15, when in contact with a p-type material of the invention, can inhibit or substantially inhibit the oxidation of the p-type material because of the reducible nature of the metal particles 15. The metal particles 15 can be of any size compatible with the n-type semiconductor material 10. In some embodiments, the metal particles 15 are nanostructures. The nanostructures can be of any form suitable for use in the photoactive catalytic systems of the present invention, including but not limited to nanowires, nanoparticles, nanoclusters, nanocrystals, or combinations thereof.

The p-type semiconductor material (i.e., cobalt or copper) can also be obtained from a variety of commercial sources in a variety of forms (e.g., particles, rods, films, etc.) and sizes (e.g., Nano scale or Micro scale). By way of example, each of Sigma-Aldrich® Co. LLC and Alfa Aesar GmbH & Co KG, offer such products. Alternatively, they can be made by any process known by those of ordinary skill in the art such as precipitation or impregnation methods. The p-type materials can be cobalt or copper oxides in their reduced state (for example, CoO (Co II) and Cu₂O (Cu I). These metals when in contact with the n-type material forms a p-n-junction. The p-type materials can be of any size compatible with the n-type semiconductor material and the plasmon resonance materials. In some embodiments, the metal oxides are nanostructures. The nanostructures can be of any form suitable for use in the photoactive catalytic systems of the present invention, including but not limited to nanowires, nanoparticles, nanoclusters, nanocrystals, or combinations thereof.

Referring to FIG. 3, the photoactive catalysts 30 of the present invention can be prepared from the aforementioned n-type material 10, the metal particles 15, and the p-type material 16 by using the process described in the Examples section of this specification. A non-limiting example of a method that can be used to make the photoactive catalysts 20 of the present invention includes formation of an aqueous solutions of titanium dioxide particles 11, 12 in the presence of CoO particles 16 followed precipitation where the metal particles CoO particles 16 are attached to a least a portion of the surface of the n-type semiconductor material 10 (e.g., precipitated titanium dioxide crystals or particles 11, 12). The n-type and p-type particles can be mixed with aqueous solutions of plasmonic resonance metals, (for example, Au, Ag, and Pd precursors), followed by precipitation, where the metal particles 15 are attached to at least a portion of the surface of the precipitated n-type and p-type materials. Alternatively, the metal particles 15 can be deposed on the surface of the n-type and p-type materials by any process known by those of ordinary skill in the art. Deposition can include attachment, dispersion, and/or distribution of the metal particles 15 on the surface of the photoactive active material or TiO₂—CoO particles. As another non-limiting example, the photoactive material (e.g., TiO₂—CoO particles) can be mixed in a volatile solvent with the metal particles 15. After stirring and sonication, the solvent can be evaporated off. The dry material can then be ground into a fine powder and calcined (such as at 300° C.) to produce the photoactive catalysts 30 of the present invention. Calcination (such as at 300° C.) can be used to further crystalize the TiO₂—CoO particles. FIG. 3 is a schematic representation of the photocatalyst that includes the metals 15 and a photoactive material containing the n-type material 10 and the p-type material 16. The n-type material (for example, TiO₂) 10 is in contact with the p-type material (CoO) 16. The metals (for example, Au or Ag—Pd) 15 are in contact with both the n-type material 10 and the p-type material 16. Contact of the n-type material 12 with the p-type material 16 forms p-n junction 17. The electric field 18 is generated by the plasmon resonance materials in response to visible light.

### B. Water-Splitting System

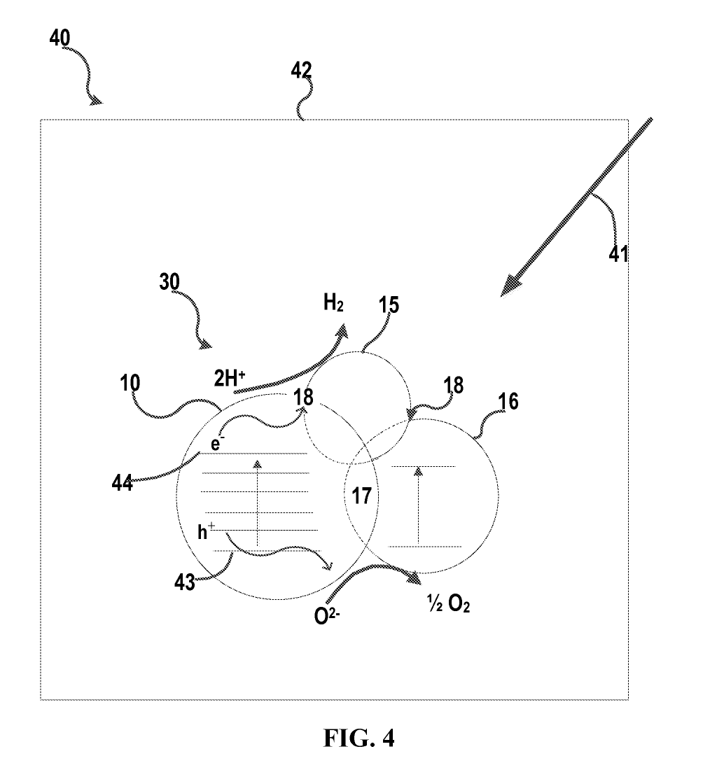

Referring to FIG. 4, a non-limiting representation of a water-splitting system 40 of the present invention is provided. The system includes the photocatalyst 30, a light source 41, and container 42. The photocatalyst includes the photoactive material and the metal particles 15 attached to the surface of n-type semiconductor material 10 and p-type semiconductor material 16 of the photoactive material. The container 42 can be a transparent, translucent or even opaque such as those that can magnify light (e.g., opaque container having a pinhole(s)). The photocatalyst 30 can be used to split water to produce H₂ and O₂. The light source 41 includes visible and (400-600 nm) and ultraviolet light (360-410). The ultraviolet light excites both the n-type material 10 and the p-type material 16, while the visible light excites the p-type material and by “resonance” electrons from Au and Ag atoms (plasmonic excitation) both affect the width of the depletion width at the p-n junction 17. The exciting electrons (e⁻) from their valence band 43 to their conductive band 44 of both p- and n-type semiconductors, thereby leaving a corresponding hole (h⁺). The excited electrons (e⁻) are used to reduce hydrogen ions to form hydrogen gas, and the holes (h⁺) are used to oxidize oxygen ions to oxygen gas. The hydrogen gas and the oxygen gas can then be collected and used in down-stream processes. Due to the p-n junction 17 and the highly conductive metal particles 15 dispersed on the surface of the photoactive material 10, excited electrons (e⁻) are more likely to be used to split water before recombining with a hole (h⁺) than would otherwise be the case. Notably, the system 40 does not require the use of an external bias or voltage source. Further, the efficiency of the system 40 allows for one to avoid or use minimal amounts of a sacrificial agent such as methanol, ethanol, propanol, butanol, isobutanol, methyl tert-butyl ether, ethylene glycol, propylene glycol, glycerol, oxalic acid, or any combination thereof. In certain aspects, however, 0.1 to 10 w/v %, or preferably 2 to 7 w/v %, of a sacrificial agent can be included in the aqueous solution. The presence of the sacrificial agent can increase the efficiency of the system 40 by further reducing the likelihood of hole/electron recombination via oxidation of the sacrificial agent by the hole rather than recombination with the excited electron. Preferred sacrificial agents ethylene glycol, glycerol, or a combination thereof is used. In addition to being capable of catalyzing water splitting without an external bias or voltage, the photocatalysts of the present invention may be included in an anode of an electrochemical cell capable of forming oxygen and hydrogen by electrolysis of water. In a non-limiting example, light energy may be provided to a photocell and from the light energy a voltage between the anode and the cathode is produced and water molecules are split to form hydrogen and oxygen. The method can be practiced such that the hydrogen production rate from water can be modified as desired by subjecting the system to various amounts of light energy or light flux. For example, the photoactive catalyst 20 can be used as the anode in a transparent container containing an aqueous solution and used in a water-splitting system. An appropriate cathode can be used such as Mo—Pt cathodes (See, International Journal of Hydrogen Energy, June 2006, Vol. 31, issue 7, pages 841-846, the contents of which are incorporated herein by reference) or MoS₂ cathodes (See, International Journal of Hydrogen Energy, February 2013, Vol. 38, issue 4, pages 1745-1757, the contents of which are incorporated herein by reference).

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Production of Photocatalysts of the Present Invention

CoO—TiO₂ Substrate.

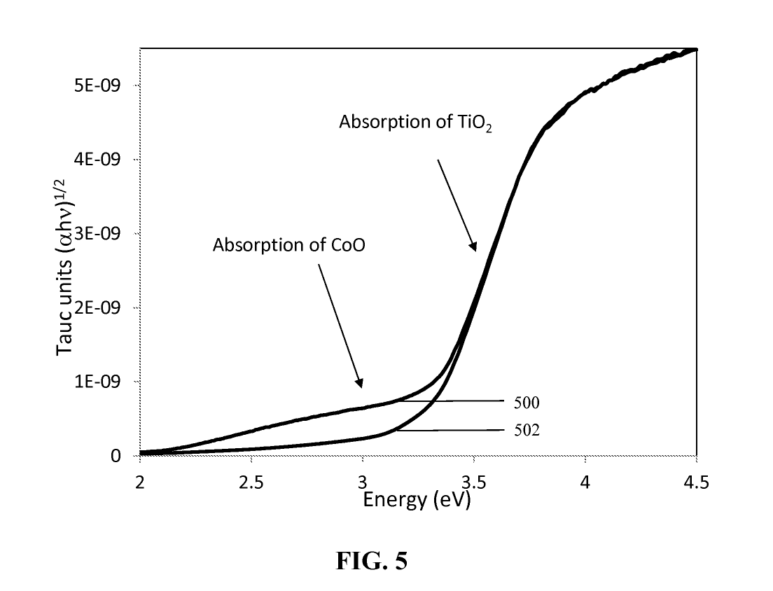

The CoO—TiO₂ substrate was made using a co-impregnation method to obtain the CoO loading listed in Table 1 on the TiO₂ substrate. The TiO₂ semiconductor was either prepared by a sol-gel method (see, for example, Chen et al., Chem. Rev. 2010 Vol. 110, pp. 6503-6570) or purchased as Hombikat TiO₂ from a commercial source (for example, Sigma-Aldrich®, USA, Sachtleben Chemie GmbH, Germany). The TiO₂ was in an anatase phase or an anatase-rutile mixed phase as listed in Table 1. The TiO₂ was placed into a mixed (170 rpm) with a stock solution of Co(NO₃)₂ 6H₂O at 80° C. for 12 to 24 hours, until a pasted formed. The amount of Co(NO₃)₂ 6H₂O used was determined based on the amount of cobalt to be loaded on the titanium dioxide substrate. The paste was dried for at greater than 4 hours at 120° C., and then calcined at 350° C. for 5 hours with a ramp temperature of 10° C./min. The calcined substrate was crushed using a mortar and pestle to obtain small particles of CoO—TiO₂ semiconductor material listed in Table 1. FIG. 5 is a ultra violet/visible absorption spectrum of CoO—TiO₂ anatase rutile phases semiconductor material with 2 wt. % Co (Sample 3, data line 500) and 0.5 wt. % Co (data line 502), respectively. The absorption of TiO₂ was about 3.0-3.2 electron volts and the CoO was 2.2-2.7 electron volts.

TABLE 1

| Sample | TiO₂ | | Cobalt Oxide on |
|---|---|---|---|
| No. | (g) | Phase of TiO₂ | TiO₂ (wt. %) |
| 1 | 10 | Anatase + Rutile | 0.5 |
| 2 | 1 | Anatase + Rutile | 1 |
| 3 | 2 | Anatase + Rutile | 2 |
| 4 | 5 | Anatase + Rutile | 5 |
| 5 | 2 | Anatase | 2 |

Ag—Pd CoO—TiO₂ Photocatalyst—Sample 6.

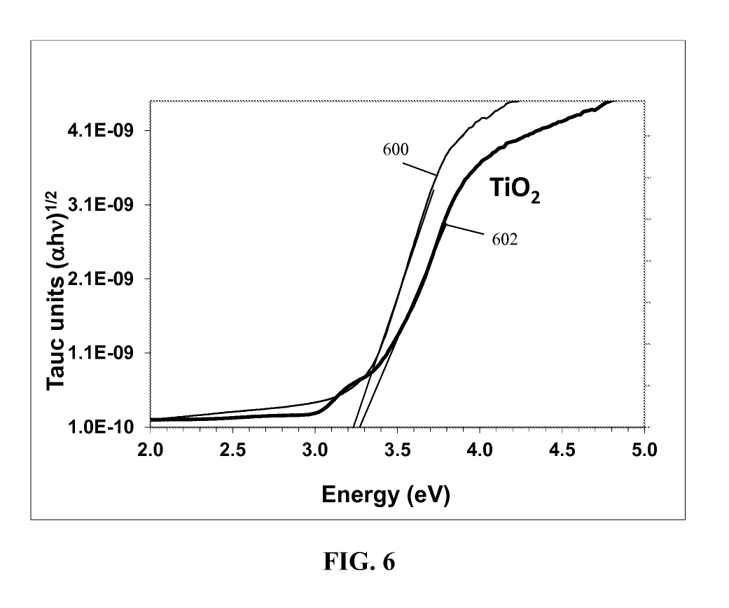

The Ag—Pd/CoO—TiO₂ photocatalyst was made using a co-impregnation to obtain the Ag and Pd loading 0.1 wt. % Ag, 0.4 wt. % Pd on a 2 wt. % CoO on TiO₂ anatase support (Sample 5 in Table 1), The metal precursors AgNO₃ and Pd(CH₃COO)₂ were obtained from Sigma Aldrich® and had a purity of 100% to 99.9%, respectively. A reactor equipped with a stirring apparatus and a condenser was charged with CoO—TiO₂ semiconductor material (2 grams) a stock solution of aqueous AgNO₃ and a stock solution of Pd(CH₃COO)₂ to obtain the metal loading of 0.1 wt. % Ag and 0.4 wt. % Pd, polyvinyl alcohol (PVA to metal ratio of 10 wt/wt), and ethylene glycol (15 mL). The mixture was heated with stirring to 180 to 200° C. for 12 to 24 hours. The condenser was removed and the mixture was heated under stirring under the mixture solidified. The resulting solid was dried at 100 to 110° C. for 12 hours, and then calcined at 350° C. for 5 hours to obtain the Ag—Pd/CoO—TiO₂ photocatalyst of the present invention (Sample 6). FIG. 6 is a ultra violet/visible absorption spectrum of the Ag—Pd/CoO—TiO₂ semiconductor material with 0.1 wt. % Ag, 0.4 wt. % Pd, 2 wt. % Co on TiO₂ anatase (data line 600) and TiO₂ (data line 602). The absorption of Ag—Pd/CoO—TiO₂ was observed to be higher than the TiO₂ substrate. This increased adsorption was attributed to the plasmonic resonance effect of the metals with the CoO—TiO₂ semiconductor material.

### Example 2

### Use of the Photocatalysts of the Invention in Water-Splitting Reactions

Water-Splitting Reaction Using Sample 6.

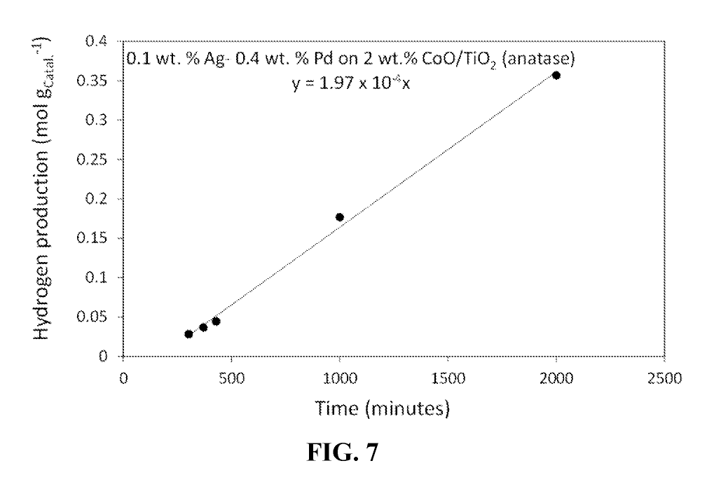

Catalytic reactions were conducted in a borosilicate (Pyrex®, Corning) glass reactor having a capacity of 100 mL. Photocatalyst was added to the glass reactor in a concentration of 0.1 g/L (Sample No. 6, 10 mg in 21 mL total volume). The photocatalyst was reduced under hydrogen flow at 350° C. for 1 h followed by purging with nitrogen gas for 30 minutes. Deionized water (20 mL) and sacrificial agent (ethanol, 5 v/v % based on total water, 1 mL) were added to the reactor. The reaction mixture was irradiated with sunlight, with a light flux at the front side of the reactor of between 0.3 and 1 mW/cm². The mixture containing photocatalyst, water and sacrificial agent was stirred constantly under dark conditions to disperse the catalyst and sacrificial agent in the water. The reactor was then exposed to a UV light source (100 Watt UV lamp (H-144GC-100, Sylvania par 38) with a flux of about 2 mW/cm2 at a distance of 10 cm with the cut off filter (360 nm and above). Product analysis of the produced gas was done using a gas chromatography (Porapak™ Q (Sigma Aldrich) packed column 2 m, 45° C. (isothermal), with nitrogen as a carrier gas) with a thermal conductivity detector. FIG. 7 is a graph of hydrogen production versus time for the 0.1 wt % Ag, 0.4 wt. % Pd on 2 wt. % CoO/TiO₂ (anatase). The molar ratio of Ag to Pd was 0.25 and the rate of hydrogen production was 2×10⁻⁴ mole g_{Catal}⁻¹ min⁻¹.

### Example 3

### Comparative Examples

General Procedure.

Catalytic reactions were conducted in a borosilicate (Pyrex®, Corning) glass reactor having a capacity of 100 mL. For each experiment, a photocatalyst was added to the glass reactor in a concentration of 0.1 g/L (10 mg in 21 mL total volume). The photocatalyst was reduced under hydrogen flow at 350° C. for 1 h followed by purging with nitrogen gas for 30 minutes. Deionized water (20 mL) and sacrificial agent (ethanol, 5 v/v % based on total water, 1 mL) were added to the reactor. The reaction mixture was irradiated with sunlight, with a light flux at the front side of the reactor of between 0.3 and 1 mW/cm². The mixture containing photocatalyst, water and sacrificial agent was stirred constantly under dark conditions to disperse the catalyst and sacrificial agent in the water. The reactor was then exposed to a UV light source (100 Watt UV lamp (H-144GC-100, Sylvania par 38) with a flux of about 2 mW/cm² at a distance of 10 cm with the cut off filter (360 nm and above). Product analysis of the produced gas was done using a gas chromatography (Porapak™ Q (Sigma Aldrich) packed column 2 m, 45° C. (isothermal), with nitrogen as a carrier gas) with a thermal conductivity detector.

Water-Splitting Using a Comparative CoO/TiO₂ Photocatalyst.

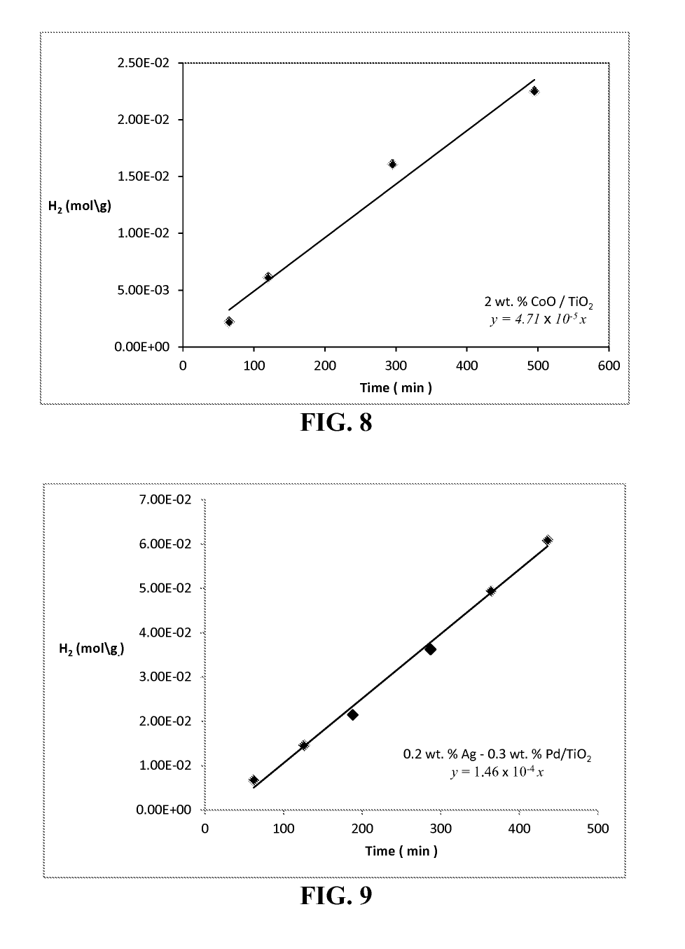

Mixed phased titanium dioxide anatase and rutile particles were doped with cobalt oxide to produce the CoO/TiO₂ photocatalyst having the wt. % of cobalt oxide per total weight of catalyst listed in Table 3. These catalyst were used generate hydrogen and oxygen from water in water-splitting reactions. The rates of hydrogen production (moles of H₂ per gram of catalyst per min) from the splitting of water using the CoO/TiO₂ catalysts are listed in Table 2. FIG. 8 is a graph of hydrogen production versus time for a comparative CoO/TiO₂ catalyst with 2 wt % CoO.

TABLE 2

| | Cobalt Oxide | Rate |
|---|---|---|
| Sample No. | (wt. %) | (mol/g_{cat} · min) |
| C1 | 0.5 | 2 × 10⁻⁵ |
| C2 | 1 | 4 × 10⁻⁵ |
| C3 | 2 | 5 × 10⁻⁵ |
| C4 | 5 | 4 × 10⁻⁵ |

Water-Splitting Using a Ag—Pd/TiO₂ Photocatalyst.

Mixed phase titanium dioxide anatase and rutile particles were doped with silver and palladium metals to produce the Ag—Pd/TiO₂ photocatalyst having 1 wt. % of total metals (silver and palladium) in the catalyst and the molar ratio of the silver to palladium listed in Table 3. These catalyst were used generate hydrogen and oxygen from water in water-splitting reactions. The rates of hydrogen production (moles of H₂ per gram of catalyst per min) from the splitting of water using the Ag—Pd/TiO₂ catalysts are listed in Table 4.

TABLE 3

| | Ag—Pd | Rate |
|---|---|---|
| Sample No. | (ratio) | (mol/g_{cat} · min) |
| C5 | 0.25 | 9 × 10⁻⁵ |
| C6 | 0.66 | 7 × 10⁻⁵ |
| C7 | 1 | 6 × 10⁻⁵ |
| C8 | 1.33 | 11 × 10⁻⁵ |
| C9 | 4 | 7 × 10⁻⁵ |

Water-Splitting Using a Ag—Pd/TiO₂ Photocatalyst.

Titanium dioxide particles were doped with silver and palladium metals to produce the Ag—Pd/TiO₂ photocatalyst having 0.5 wt. % of total metals (C) in the catalyst. These catalysts were used generate hydrogen and oxygen from water in water-splitting reactions. The rates of hydrogen production (moles of H₂ per gram of catalyst per min) from the splitting of water using the Ag—Pd/TiO₂ catalysts are listed in Table 4. FIG. 9 is a graph of hydrogen production versus time for the Ag—Pd/TiO₂ having 0.5 wt. % of metals and a molar ratio of Ag to Pd of 0.66.

TABLE 4

| | Ag—Pd | Rate |
|---|---|---|
| Sample No. | (ratio) | (mol/g_{cat} · min) |
| C10 | 0.25 | 14 × 10⁻⁵ |
| C11 | 0.66 | 15 × 10⁻⁵ |
| C12 | 1 | 9 × 10⁻⁵ |
| C13 | 1.33 | 9 × 10⁻⁵ |
| C14 | 4 | 12 × 10⁻⁵ |

The production of hydrogen (2×10⁻⁴ mole per gram of catalyst per min) of the bi-metallic catalyst (Sample No. 6, Ag—Pd CoO/TiO₂) was found to be about 1.5 times higher than the Comparative sample No. C10 doped with the same amount of Ag and Pd in the same ratio. Thus, the photocatalyst of the invention has improved efficiency of hydrogen production as compared to conventional photocatalysts. It is to be noted that in Sample 6 a longer induction period than Comparative Sample C10 and C11 (shown in FIG. 9). Without wishing to be bound by theory it is believed that the induction period was due to reduction of the metal particles at the interface with CoO because the latter is more prone to donating its oxygen to the metal when compared to TiO₂.

1. A photocatalyst comprising:
a photoactive material comprising a n-type semiconductor material and a p-type semiconductor material, wherein a p-n junction is present at an interface of the p-type and n-type materials; and
a metal or metal alloy material having surface plasmon resonance properties in response to visible light and/or infrared light,
wherein the metal or metal alloy material is deposited on the surface of the photoactive material.

2. The photocatalyst of claim 1, wherein the n-type semiconductor material comprises titanium dioxide or zinc oxide.

3. The photocatalyst of claim 2, wherein the n-type semiconductor material comprises titanium dioxide that has an anatase to rutile ratio of greater than or equal to 1.5:1.

4. The photocatalyst of claim 1, wherein the p-type semiconductor material comprises cobalt (II) oxide or copper (I) oxide.

5. The photocatalyst of claim 1, wherein the n-type semiconductor material comprises titanium dioxide having an anatase to rutile ratio of greater than or equal to 2:1 and the p-type semiconductor material comprises cobalt (II) oxide.

6. The photocatalyst of claim 1, wherein the metal or metal alloy material is gold, silver-gold-palladium alloy, or silver-palladium alloy, respectively, or a mixture thereof.

7. The photocatalyst of claim 1, wherein the n-type material, the p-type material, and the metal or metal alloy material are each in particulate form.

8. The photocatalyst of claim 7, wherein the n-type material, the p-type material, and the metal or metal alloy material are each nanostructures, wherein the nanostructures are nanowires, nanoparticles, nanoclusters, or nanocrystals, or combinations thereof.

9. The photocatalyst of claim 1, comprising less than 5 wt. % of the metal or metal alloy material.

10. The photocatalyst of claim 1, wherein the metal or metal alloy material does not cover more than 30% of the surface area of the photoactive material.

11. The photocatalyst of claim 1, wherein the ratio of the n-type semiconductor material to the p-type semiconductor material is 75 to 25.

12. The photocatalyst of claim 1, wherein the photocatalyst is deposited onto a substrate such as an indium tin oxide substrate, a stainless steel substrate, silicon oxide, aluminum oxide, zirconium oxide, or magnesium oxide.

13. The photocatalyst of claim 1, wherein the photocatalyst is capable of catalyzing the splitting of water.

14. (canceled)

15. The photocatalyst of claim 1, wherein the photocatalyst is capable of catalyzing the photocatalytic oxidation of an organic compound.

16. A composition comprising the photocatalyst of claim 1.

17. The composition of claim 16, comprising 0.1 to 2 g/L of the photocatalyst.

18. The composition of claim 16, further comprising water, a sacrificial agent or both.

19. The composition of claim 18, comprising 1 to 10 w/v % or 2 to 7 w/v % of the sacrificial agent.

20. (canceled)

21. A method of producing hydrogen gas by photocatalytic water-splitting, the method comprising irradiating an aqueous solution comprising the with light photocatalyst of claim 1 under conditions suitable to split water molecules to form hydrogen and oxygen.

22-24. (canceled)

25. The photocatalyst of claim 1, wherein the ratio of the n-type semiconductor material to the p-type semiconductor material is 80 to 20.
